(19) United States
(12) Patent Application Publication
(10) Pub. No.: US 2023/0409956 A1
(43) Pub. Date: Dec. 21, 2023

(54) MACHINE LEARNING PREDICTION OF ADDITIONAL STEPS OF A COMPUTERIZED WORKFLOW

(71) Applicant: ServiceNow, Inc., Santa Clara, CA (US)

(72) Inventors: Amine El Hattami, Montreal (CA); Christopher Joseph Pal, Montreal (CA)

(21) Appl. No.: 17/752,555

(22) Filed: May 24, 2022

(51) Int. Cl. G06N 20/00; G06Q 10/06

(52) U.S. Cl. CPC G06N 20/00; G06Q 10/0633

(57) ABSTRACT

An indication to predict one or more additional steps to be added to a partially specified computerized workflow based at least in part on the partially specified computerized workflow is received. Text descriptive of at least a portion of the partially specified computerized workflow is generated. Machine learning inputs based at least in part on the descriptive text are provided to a machine learning model to determine an output text descriptive of the one or more additional steps to be added. One or more processors are used to automatically implement the one or more additional steps to be added to the partially specified computerized workflow.

### BACKGROUND OF THE INVENTION

Machine-assisted development of computer instructions allows for developers to create executable sequences of computer actions without requiring significant knowledge of a computer language. Computer instructions can be in the form of automated processes, computer programs, or other collections of instructions that tell a computer how to operate. To develop computer instructions, for example, developers can interact with a graphical user interface of a development tool. However, sometimes, developers may be challenged by the difficulty of learning to use the development tool. They may be overwhelmed by the many options within the development tool and may not utilize best practices. Thus, there is a need for techniques to assist developers in this regard.

### BRIEF DESCRIPTION OF THE DRAWINGS

Various embodiments of the invention are disclosed in the following detailed description and the accompanying drawings.

FIG. 1 is a block diagram illustrating an embodiment of a system for automatically predicting and implementing additional steps of a computerized flow.

FIG. 2 is a diagram illustrating an example of a computerized flow.

FIG. 3 is a diagram illustrating an example of an automatically implemented computerized flow that promotes best practices.

FIG. 4 is a flow diagram illustrating an embodiment of a process for synthetically generating training data.

FIGS. 5A-B are diagrams illustrating user interface examples associated with automatically predicting and implementing additional steps of a computerized flow.

FIG. 6 is a flow diagram illustrating an embodiment of a process for automatically predicting and implementing additional steps of a computerized flow.

FIG. 7 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Machine learning prediction of additional steps of a computerized workflow is disclosed. An indication to predict one or more additional steps to be added to a partially specified computerized workflow based at least in part on the partially specified computerized workflow is received. Text descriptive of at least a portion of the partially specified computerized workflow is generated. Machine learning inputs based at least in part on the descriptive text are provided to a machine learning model to determine an output text descriptive of the one or more additional steps to be added. One or more processors are used to automatically implement the one or more additional steps to be added to the partially specified computerized workflow.

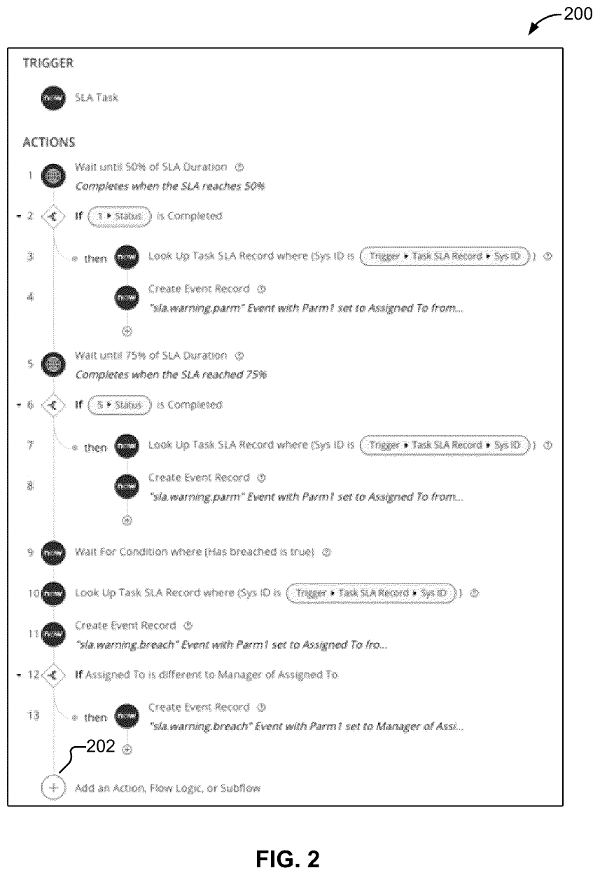

Many low-code environments rely on a graphical user interface, which hides executable code associated with workflows. As used herein, a workflow, which can also be called a “computerized workflow”, “computerized flow”, “automation flow”, “action flow”, “flow”, and so forth, refers to an automatic process (e.g., performed by a programmed computer system) comprised of a sequence of actions. The sequence of actions can also be called a sequence of steps, sequence of action steps, etc. Oftentimes, a workflow also includes a trigger for the sequence of actions. Examples of flows are shown in FIGS. 2, 3, and 5A-B. The techniques disclosed herein solve the technological problem of allowing for efficient computerized workflow steps generation in scenarios in which the use of a graphical user interface is difficult. Using a graphical user interface can be challenging for inexperienced users, especially since there may be hundreds of available steps from which to choose. The techniques disclosed herein have many benefits, including reducing the user learning curve, promoting best practices for inexperienced users, and helping experienced users discover new features.

In various embodiments, the techniques disclosed herein utilize large, pre-trained models, leading to a highly adaptable system that requires few or no labeled samples. The techniques disclosed herein are widely applicable to different types of automation flow builder applications. In various embodiments, as described in further detail herein, a trained machine learning model receives an incomplete flow in a text format and then predicts next step(s) based on patterns found in training data. Manual processing and feature engineering are not required because the machine learning model has learned to perform this task using a large set of examples during training. In various embodiments, the machine learning model's output is converted to application programming interface (API) calls to be transmitted to a flow builder application. These techniques are described in further detail below.

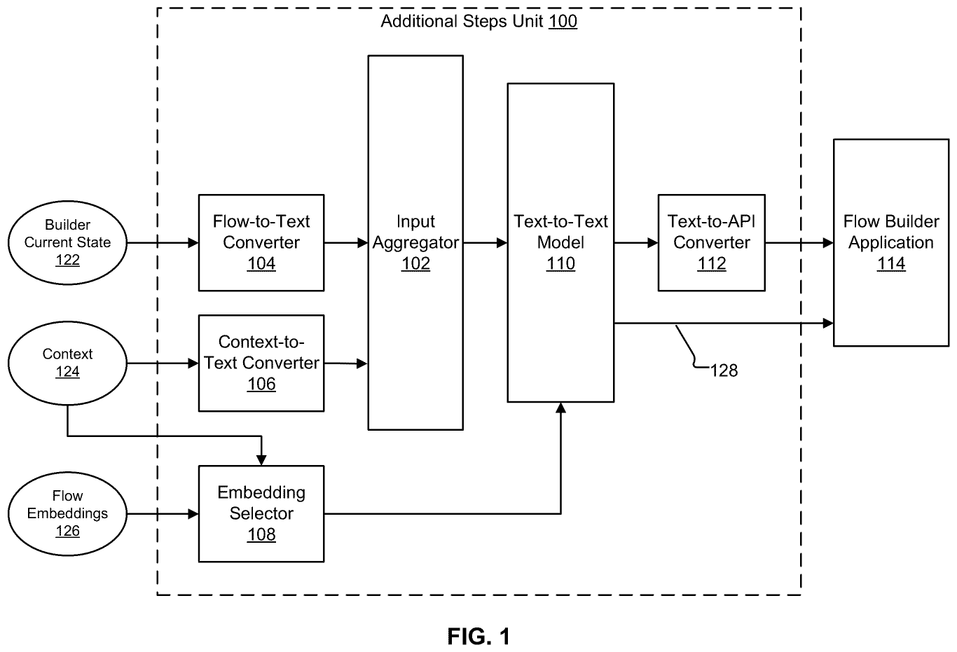

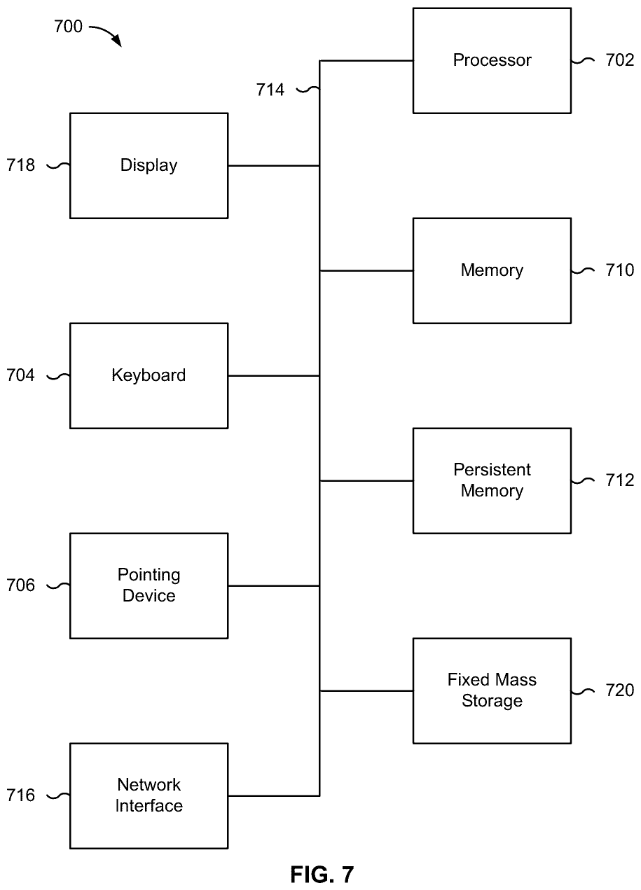

FIG. 1 is a block diagram illustrating an embodiment of a system for automatically predicting and implementing additional steps of a computerized flow. In the example illustrated, additional steps unit 100 is comprised of input aggregator 102, flow-to-text converter 104, context-to-text converter 106, embedding selector 108, text-to-text model 110, and text-to-API converter 112. In the example shown, flow builder application 114 is separate from additional steps unit 100, but it is also possible, in alternative embodiments, for flow builder application 114 to be incorporated as a component of additional steps unit 100. In some embodiments, additional steps unit 100 (including its components) is comprised of computer program instructions that are executed on a general-purpose processor, e.g., a central processing unit (CPU), of a programmed computer system. FIG. 7 illustrates an example of a programmed computer system. It is also possible for the logic of additional steps unit 100 to be executed on other hardware, e.g., executed using an application-specific integrated circuit (ASIC) or a field-programmable gate array (FPGA). In the example illustrated, additional steps unit 100 provides outputs to flow builder application 114. In various embodiments, flow builder application 114 includes software that can be interfaced with via an API. In the example illustrated, the input data to additional steps unit 100 are builder current state 122, context 124, and flow embeddings 126.

In various embodiments, input aggregator 102 creates input text for text-to-text model 110. In the example illustrated, input aggregator 102 receives text inputs from flow-to-text converter 104 and context-to-text converter 106. In various embodiments, input aggregator 102 determines a flow description based on the output of flow-to-text converter 104 and combines this with context information that is a text output of context-to-text converter 106. In some embodiments, there is a specified order in which the information is combined because starting with the elements that have more influence on the output of text-to-text model 110 can lead to improved results.

In the example illustrated, builder current state 122 is a mandatory input used to predict a partial flow. Predicting a partial flow adds steps to an incomplete flow either by specifying a single step or multiple steps. The single-step use case can enable the techniques disclosed herein to work in a chatbot-like system where the user provides interaction to create the flow step-by-step. In various embodiments, builder current state 122 includes two items: 1) existing steps: the steps already created by the user by using a user interface, from a previous call to additional steps unit 100, or using another step generation technique; and 2) current position: the position from which the user had requested to generate next steps (stated alternatively, the index in the existing steps list). In the example shown, builder current state 122 is received by flow-to-text converter 104. Flow-to-text converter 104 converts the existing (incomplete) flow to a text format. In some embodiments, the existing steps in builder current state 122 are in either an Extensible Markup Language (XML) or JavaScript Object Notation (JSON) format. Thus, in some embodiments, flow-to-text converter 104 converts XML or JSON data to text. Builder current state 122 can be in any known data format (e.g., XML, JSON, etc.). The examples of XML and JSON are merely illustrative and not restrictive.

Suppose the existing steps are “Send Email” (“Send Email” being the step name) and “Create Incident Record” (“Create a record” being the step name and “Incident” being a step parameter that represents a table name). The current position would be the third position and indicates the insertion point. In various embodiments, flow-to-text converter 104 first serializes the existing steps by converting each one from name to description using a one-to-one mapping and extracting any existing step parameter. The output that is generated may be in the format: “Existing Steps: step 1 [parameter 1], step 2, . . . , step N [parameter N] Current Position: X”. In this format, “Existing Steps” and “Current Position” are prefixes that differentiate the existing steps from the current position. This is needed because the output of flow-to-text converter 104 is in a text format. Text-to-text model 110 can verify how likely a specific step is to occur given the previous ones and their parameters learned during the training phase of text-to-text model 110.

In the example illustrated, context 124 is an optional input. Context 124 may be used to condition text-to-text model 110's output. This conditioning aims to refine text-to-text model 110's prediction based on external factors. With respect to context 124, text-to-text model 110 is able to use specific available context items to modulate its output. For example, depending on the creator of the flow, or the business unit, the handling of some cases such as the error handling, logging, or managing approvals can be different. For example, a user or set of users might send an email to an administrator if the flow fails, while others will log an error message and terminate the flow. Context 124 affects text-to-text model 110 through patterns in the training data used to train text-to-text model 110. In some embodiments, context 124 includes the following items: 1) application metadata: application properties such as application name, business unit, creator, etc.; 2) flow metadata: flow properties such as title, creation date, creator, etc.; and 3) preferences, e.g., embedding ID (as described in further detail below with respect to flow embeddings). Context 124 may be in an XML, JSON, or other known data format. The above can be considered conditioning parameters for text-to-text model 110.

In various embodiments, context-to-text converter 106 receives context 124 (e.g., in an XML or JSON format) and encodes all the elements of the context except the flow embedding ID into a text format. In various embodiments, all the elements of the context are represented as a list of key-value pairs, which means that the text output of context-to-text converter 106 can be formatted in the following manner: “Preferences: key 1[Value 1], . . . , Key n [Value n] App Metadata: key 1[Value 1], . . . , Key n [Value n] Flow Metadata: key 1[Value 1], . . . , Key n [Value n]”. “Preferences”, “App Metadata”, and “Flow Metadata” are prefixes that differentiate each part of the serialized text. Context-to-text converter 106 does not require having all the context items available, meaning that, e.g., if the flow metadata is missing, flow-to-text converter 106 will only serialize the other available items. In scenarios in which the entire context is unavailable, context-to-text converter 106 outputs an empty string.

In the example illustrated, flow embeddings 126 is another optional input. Flow embeddings 126 includes a list of previously learned flow embeddings. In various embodiments, flow embeddings 126 comprises embeddings that have been based on existing flows and that can be used to condition text-to-text model 110 on how to predict next steps in a flow. Such conditioning can tailor text-to-text model 110's output to resemble previously created flows. In some embodiments, flow embeddings 126 is a list of fixed-sized tensors that are learned individually during training of text-to-text model 110. Each flow embedding can be related to a single dataset and can be stored on a disk or in memory. The embeddings can be viewed as a way to describe the differences between training using one set of data versus another and as a way to factorize model weights. For example, two different datasets may be used during a training stage to train a single machine learning model with a single set of model weights and two different embeddings (different embeddings for each of the datasets). Then, during deployment of the machine learning model in inference mode, the embeddings can be swapped to match each training dataset without interrupting the machine learning model. While it is possible to achieve similar results without using the embeddings by training two different models, using embeddings reduces computational and other costs because only a single model needs to be created, deployed, and maintained. Notwithstanding the above, it is also possible to train two different models and use the techniques disclosed herein since the embedding feature is optional. This may be useful in scenarios in which datasets need to be separated (e.g., for confidentiality reasons). In the example shown, embedding selector 108 selects and loads an embedding (e.g., a tensor) from flow embeddings 126. This can be accomplished by using a flow embedding ID of context 124 to indicate the selection. In scenarios in which no flow embedding ID is provided, embedding selector 108 outputs a NULL tensor. In some embodiments, a selected embedding tensor is loaded to a processor implementing text-to-text model 110, e.g., a central processing unit (CPU), graphics processing unit (GPU), etc. when the embedding is selected.

In various embodiments, text-to-text model 110 predicts next step(s) of a partial flow as modulated by other available inputs, such as context or flow embeddings. In some embodiments, the flow is predicted by text-to-text model 110 in a text format as follows: “Step X N+1, Step Z N+2 [parameter 1], . . . , Step K N+K [parameter 1, . . . , parameter M]” where N is the number of existing steps, and K is the number of predicted steps. Depending on context, the output can include a single parameter, multiple parameters, or zero parameters. The number of predicted steps varies depending on where the user requests the next step. The number of predicted steps is oftentimes inversely proportional to the number of existing steps, meaning that if the user has created only two steps and then requests next steps, text-to-text model 110 may predict only one next step. However, if the user has created ten steps, text-to-text model 110 may predict five next steps. The reason for this is that text-to-text model 110 would have more confidence to predict more steps given a larger number of existing steps. In various embodiments, text-to-text model 110 outputs a confidence score associated with its prediction. In the example illustrated, this is shown as second output 128 from text-to-text model 110 directly to flow builder application 114. In some embodiments, the confidence score is the inverse of the average of the Shannon entropy of each predicted step. A high entropy indicates a high uncertainty. In various embodiments, the confidence score is a value between 0 and 1. Flow builder application 114 may utilize the confidence score to determine whether to present text-to-text model 110's prediction to a user.

The architecture of text-to-text model 110 may be based on various machine learning architectures configured to perform end-to-end learning of semantic mappings from input to output, including transformers and recurrent neural networks (RNNs) (large language models (LLMs)). Text-to-text model 110 has been trained on text examples and is configured to receive a text input and generate a text output. In various embodiments, text-to-text model 110 has been trained by utilizing transfer learning. Transfer learning refers to first pre-training a model on a data-rich task and then fine-tuning the model on a downstream task. In some embodiments, text-to-text model 110 is a LLM that has an Encoder-Decoder architecture. In various embodiments, text-to-text model 110 has been pre-trained on a multi-task mixture of unsupervised and supervised tasks for which each task is converted into a text-to-text format. An example of an LLM model with an Encoder-Decoder architecture is the T5 model.

From a model deployment perspective, using a text-to-text architecture reduces the effort to deploy a new model because it is not necessary to redo performance or hardware compatibility tests. In contrast, other machine learning models that perform classification using a single classification layer with a fixed number of output categories need to be modified when the number of classification classes changes, which can push the model response time above an upper bound that an application requires. Furthermore, if the number of classes grows exponentially, a traditional model might no longer fit the available hardware. In a traditional machine learning implementation, it may also be necessary to add a new classification component for each task in a multitask setup. In contrast, with the techniques disclosed herein, only a single configuration needs to be modified.

In some embodiments, text-to-text model 110 operates in an online continual learning cycle that requires no or minimal human intervention. In this cycle, the following steps may occur: 1) using a data collector to continuously monitor and obtain flow data and request a model trainer to initiate training of a new model after a specified number of data samples is collected; 2) causing the model trainer to use a latest model (or, if such a latest model does not exist, use a generic pre-trained model that was fine-tuned on the next step prediction task) as a starting point for training a new personalized model that fits the latest patterns and trends learned from a single user or set of users; 3) validating the personalized model by performing various checks and other testing; and 4) deploying the trained model to provide next step(s) predictions. Using either a latest or a generic model as a starting point for training has multiple advantages. First, it gives new users a good starting point (generic model) with all the typical use cases, making a model available to them early, as opposed to waiting until an acceptable amount of data is collected to fine-tune a model from scratch. Second, it makes training time shorter, which reduces the computational cost. Validating the model acts as a safeguard to avoid deploying models that have poor performance or adversarial cases, e.g., with invalid flows that affect model performance.

In the example illustrated, text-to-API converter 112 converts a text output of text-to-text model 110 to an API format. In various embodiments, text-to-API converter 112 uses a defined one-to-one mapping from step descriptions to API calls. In various embodiments, all available steps are enumerated and known by text-to-API converter 112. Stated alternatively, in various embodiments, a list of step IDs corresponding to a list of available steps that can be outputted by text-to-text model 110 is kept by text-to-API converter 112 and mapped one-to-one to a list of API calls. In the example illustrated, additional steps unit 100 does not create the final flows, but rather outputs API calls to flow builder application 114 to complete the conversion of the model output to actual steps of flows. Flow builder application 114 is instructed to create flow steps via API calls. An example of a flow builder application is the ServiceNow® Flow Designer Platform. However, this example is merely illustrative and not restrictive. The techniques disclosed herein are not limited to this builder and can be utilized with any other automation flow builder application. Handling a new builder application includes creating the step descriptions used as the output of text-to-text model 110 and updating text-to-API converter 112 with new API calls (e.g., creating one-to-one mapping updates). Furthermore, additional steps unit 100 and any of one or more flow builder applications may be integrated into a single, cohesive unit without changing the techniques disclosed herein.

In the example shown, portions of the communication path between the components are shown. Other communication paths may exist, and the example of FIG. 1 has been simplified to illustrate the example clearly. Although single instances of components have been shown to simplify the diagram, additional instances of any of the components shown in FIG. 1 may exist. The number of components and the connections shown in FIG. 1 are merely illustrative. Components not shown in FIG. 1 may also exist.

FIG. 2 is a diagram illustrating an example of a computerized flow. In the example shown, flow 200 is used to automate an information technology management process. In the example shown, flow 200 is comprised of a trigger and 13 action steps in response to the trigger. As illustrated, a step can be an action (single step), a sub-flow (a group of steps), or flow logic (e.g., an “if” statement). As another illustrative example, a flow could automate the following process: “When an email is received, create an incident record.” Here, the email reception is the trigger, and creating the incident record is the step that is to be executed when the trigger condition is met. Flow 200 is also an example of a computerized flow created using a graphical user interface environment. To create a flow in such an environment, users may rely on a set of buttons to add or modify steps. For example, in the example illustrated, button 202 can be used to add an action, sub-flow, or flow logic.

As described previously herein, using a graphical user interface to generate flows has limitations. For example, users must be familiar with the platform tables and fields that the application or process uses and are required to know all the available steps. These requirements make learning to use the graphical user interface more difficult, especially for new users and especially if the design environment has many available steps and configurations. Another limitation is that experienced users may not be aware of new functionalities and can continue to use older features and methods to build flows. In some cases, failing to use the latest features might affect the performance, stability, or security of generated flows. Training of users is a way to overcome this limitation, but it requires considerable human effort. Another limitation is that inexperienced users might not follow best practices when building flows. Some steps require additional handling, e.g., checking for errors or edge cases that affect the quality and stability of the execution of a flow. The techniques disclosed herein for automatic prediction of additional steps in an incomplete flow address the abovementioned limitations.

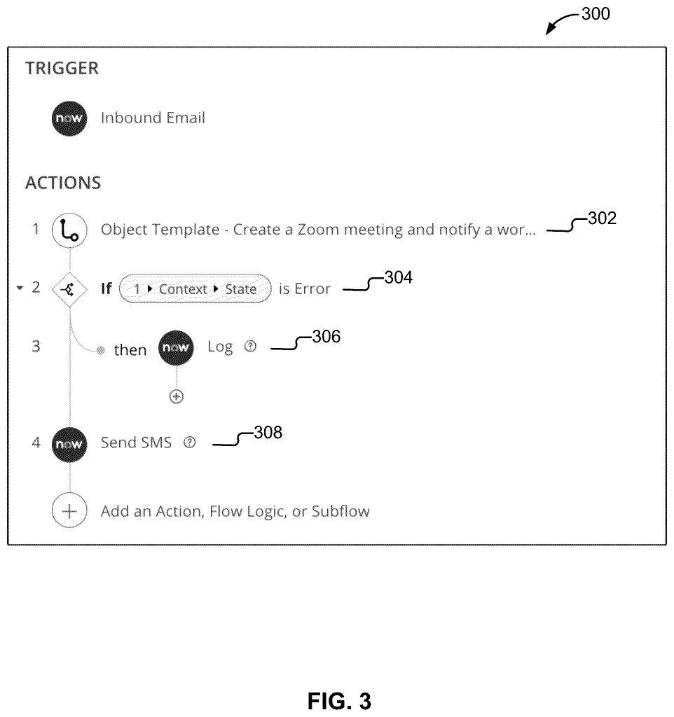

FIG. 3 is a diagram illustrating an example of an automatically implemented computerized flow that promotes best practices. As described above, users should follow best practices when constructing flows. While creating a flow via a graphical user interface, an inexperienced user may not be familiar with best practices and handling of edge cases. For example, suppose a user desires to create a Zoom meeting when a specific email is received and then send a Short Message Service (SMS) message with some information. The user would probably be aware of the need to include items 302 (create a Zoom meeting step) and 308 (send SMS step) of flow 300. However, the user may not be aware of how to create error handling steps between the create Zoom meeting step and send SMS step. These error handling steps are items 304 and 306 in flow 300. Using the techniques disclosed herein, the user would be able to request next steps prediction after generating item 302. At that point, items 304 and 306 would be automatically generated using the techniques disclosed herein, and then the user would be able to finish flow 300 by manually generating item 308. This is an example of promoting best practices (error handling items 304 and 306) that improve flows from a technical perspective. This is also an example of teaching inexperienced users to properly build computerized flows. This reduces the amount of time needed to train inexperienced users, especially when non-technical contributors are a large portion of target users. The deep learning-based techniques disclosed herein have considerable scaling potential and have advantages over rule-based approaches. For example, deep learning-based approaches can tailor model predictions to individual users.

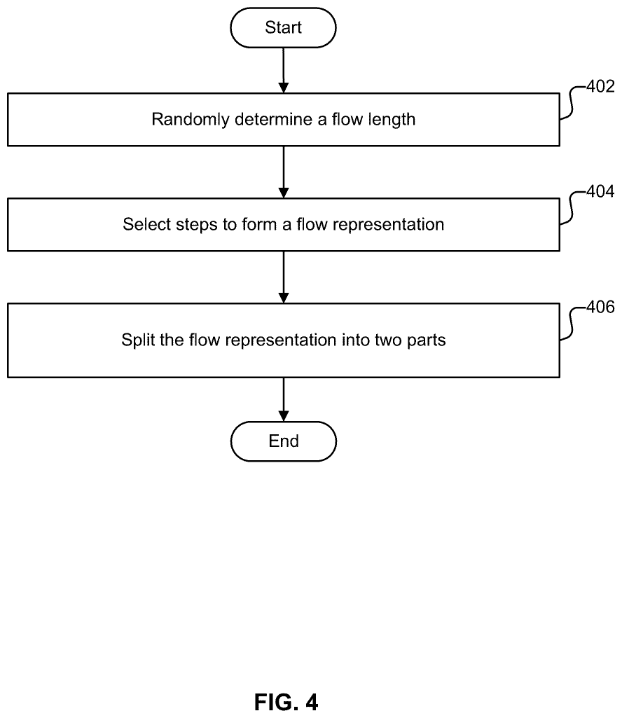

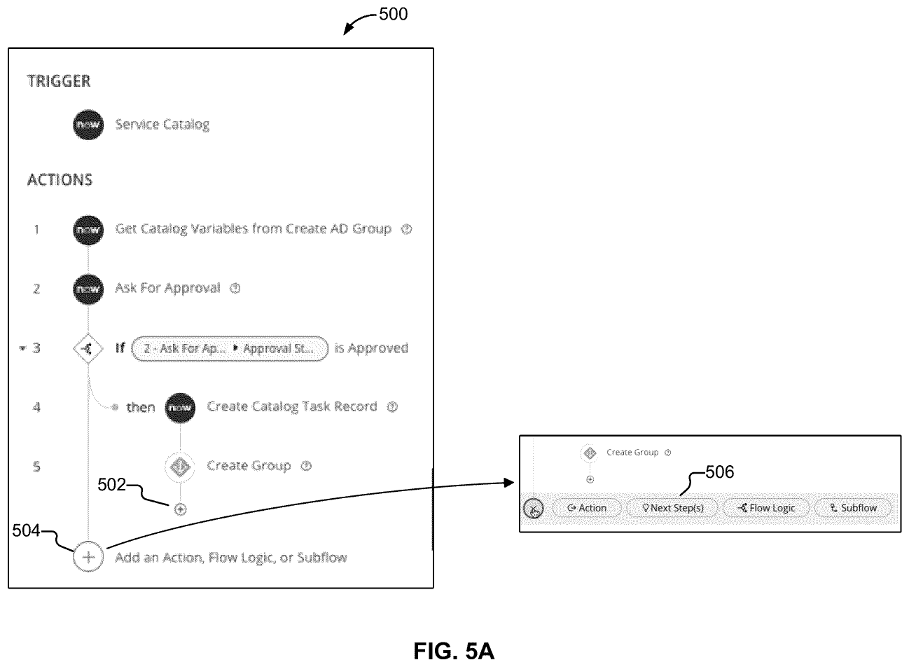

FIG. 4 is a flow diagram illustrating an embodiment of a process for synthetically generating training data. In various embodiments, the process of FIG. 4 is utilized to synthetically generate flows for machine learning model training purposes. In some embodiments, the synthetically generated training data is used to train text-to-text model 110 of FIG. 1. Text-to-text model 110 of FIG. 1 can be trained with little or no labeled training data as a result of using synthetically generated training data. It is also possible to perform traditional machine learning model training using labeled training data without using synthetically generated training data. Having a large amount of training data is important because text-to-text model 110 is a deep learning model. However, finding an acceptable amount of labeled data is a challenging task. There may be little prior work from which data can be leveraged, and labeling data is expensive because it requires manual effort. To solve these problems, in some embodiments, text-to-text model 110 is trained in two stages: a first stage in which the model is trained on a large set of synthetically generated data (a goal of this stage is learning how to predict next steps in a flow regardless of the patterns) and a second stage in which the model is trained on a smaller set of data that reflects the patterns of real users. In various embodiments, the process of FIG. 4 is utilized to generate training data for the first stage. No labeled data is required by the first stage. The second stage also does not require labeled data because existing flows can be used. Thus, using these two stages, a machine learning model can be trained without the use of labeled data. In many scenarios, these training techniques are necessary due to a scarcity of training data. Without substantial amounts of training data, machine learning based techniques may perform worse than rule-based systems.

The process of FIG. 4 can be utilized to generate a plurality of flow representation training instances. Each training instance is comprised of a model input portion and a model target portion. The model input portion is comprised of one or more flow steps that are received by a model to be trained. The model target portion is comprised of one or more additional steps that sequentially follow the model input portion. The objective is to train the model to predict model target portions (the additional steps of a flow representation) based on corresponding model input portions (the initial steps of the flow representation). Various machine learning model training techniques (e.g., backpropagation) may be utilized to determine model weights that achieve the objective of training the model to predict the model target portions based on the model input portions. In various embodiments, a unique label is assigned to each step that can possibly be utilized to form training data (model input and model target portions). Examples of labels are: “trigger_8”, “action_0”, “sub-flow_10”, etc. to describe various steps.

At 402, a flow length is randomly determined. In various embodiments, this flow length “N” is determined according to a known length distribution that matches existing usage characteristics. Stated alternatively, a representative mix of flow lengths can be determined by utilizing a statistical distribution that realistically models flow lengths that occur for one or more particular use case(s).

At 404, steps to form a flow representation are selected. Stated alternatively, N steps are selected to match the determined flow length. In some embodiments, rules and/or distributions are utilized to constrain the steps selected and/or the order of steps. For example, in various embodiments, the first step must be a trigger step and subsequent steps can be action steps. The type of trigger may be selected according to a distribution drawn from user data to conform to existing usage patterns or selected randomly. Similarly, other steps may also be selected according to corresponding distributions or selected randomly. It is also possible to utilize conditional probability distributions or other rules to constrain which steps are selected based on preceding steps. In various embodiments, the flow representation comprises a sequence of step labels in text form. For example, if the selected steps are “trigger_8”, “action_0”, and “sub-flow_10”, then the flow representation can be formatted as “trigger_8, action_0, sub-flow_10”

At 406, the flow representation is split into two parts. In various embodiments, the first part is a model input portion, and the second part is a model target portion. A machine learning model is trained to (e.g., model weights and/or biases are modified to) predict the second part when the first part is the input to the machine learning model. In some embodiments, the split point is random. In this manner, it is possible to generate training data for which model input portion and model target portion lengths vary. This training data makes it possible to train a model to predict different numbers of additional steps based on different numbers of initial steps.

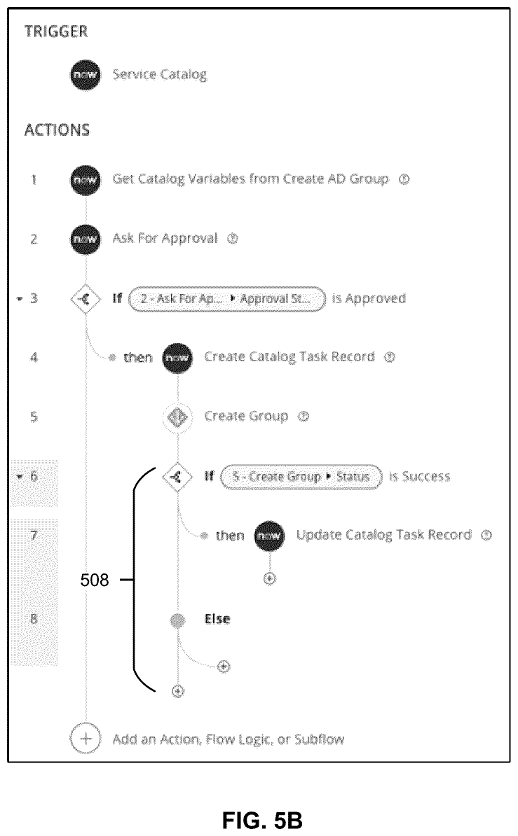

FIGS. 5A-B are diagrams illustrating user interface examples associated with automatically predicting and implementing additional steps of a computerized flow. Flow 500 in FIG. 5A is an example of an incomplete flow presented in a graphical user interface. In the example shown, additional steps need to be inserted after the fifth action step (“Create Group”) at point 502. In the example illustrated, a user can request generation of additional steps by clicking on add button 504. In this particular graphical user interface, selecting add button 504 brings up several user options (drawn to the side in a zoomed-in view for illustrative clarity). These options include, in addition to adding an action, flow logic, or sub-flow, an option to automatically generate next steps (shown as next steps button 506). In various embodiments, adding an action, flow logic, or sub-flow is a manual user process (e.g., prompting the user to select options from drop-down menus), whereas selecting next steps button 506 triggers additional steps to be generated automatically by a machine learning model. In some embodiments, this machine learning model is text-to-text model 110 of FIG. 1. In response to selecting next steps button 506, additional steps 508, shown in FIG. 5B, are added to flow 500. These additional steps are comprised of if-else steps that include error handling for the “Create Group” step. Inclusion of error handling steps is an example of promoting best practices.

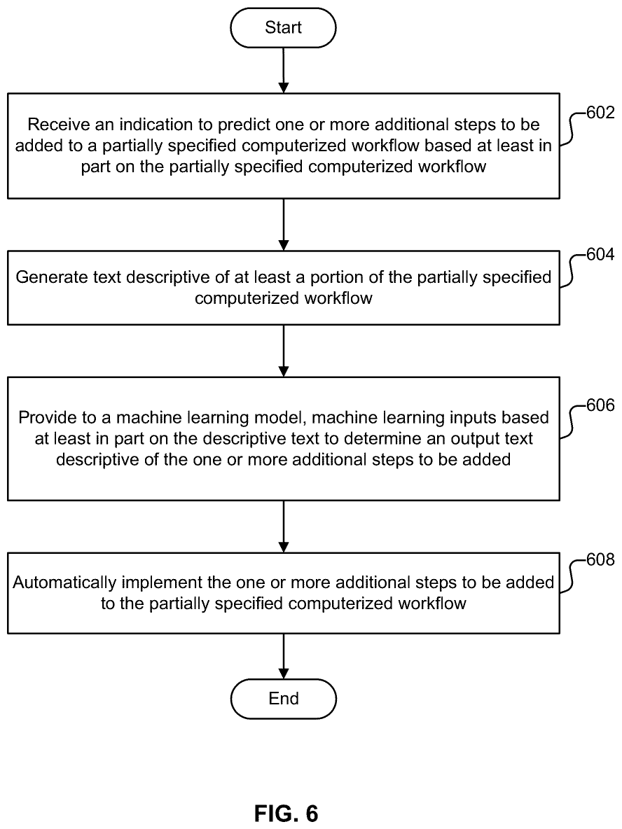

FIG. 6 is a flow diagram illustrating an embodiment of a process for automatically predicting and implementing additional steps of a computerized flow. In some embodiments, the process of FIG. 6 is performed at least in part by additional steps unit 100 of FIG. 1.

At 602, an indication to predict one or more additional steps to be added to a partially specified computerized workflow based at least in part on the partially specified computerized workflow is received. The partially specified computerized workflow may be generated manually by a user (e.g., via a graphical user interface) and/or generated automatically by one or more machine learning models. An example of a partially specified computerized workflow is flow 500 of FIG. 5A. In some embodiments, the indication to predict the one or more additional steps is received via a user interaction with a user interface element of a graphical user interface (e.g., next steps button 506 of FIG. 5A).

At 604, text descriptive of at least a portion of the partially specified computerized workflow is generated. In some embodiments, the text is converted from one or more other data formats. For example, the text may be generated by flow-to-text converter 104 of FIG. 1 and/or context-to-text converter 106 of FIG. 1.

At 606, machine learning inputs based at least in part on the descriptive text are provided to a machine learning model to determine an output text descriptive of the one or more additional steps to be added. In some embodiments, the machine learning model is text-to-text model 110. In addition to the descriptive text, the machine learning inputs can also include context parameters (e.g., context 124 of FIG. 1) and flow embedding data (e.g., selected from flow embeddings 126 of FIG. 1).

At 608, one or more processors are used to automatically implement the one or more additional steps to be added to the partially specified computerized workflow. In some embodiments, an implementation prediction is converted from the output text to API calls to a flow builder application. In some embodiments, the flow builder application is flow builder application 114 of FIG. 1.

FIG. 7 is a functional diagram illustrating a programmed computer system. In some embodiments, the processes of FIG. 4 and/or FIG. 6 are executed by computer system 700. Computer system 700 is an example of a processor.

In the example shown, computer system 700 includes various subsystems as described below. Computer system 700 includes at least one microprocessor subsystem (also referred to as a processor or a central processing unit (CPU)) 702. Computer system 700 can be physical or virtual (e.g., a virtual machine). For example, processor 702 can be implemented by a single-chip processor or by multiple processors. In some embodiments, processor 702 is a general-purpose digital processor that controls the operation of computer system 700. Using instructions retrieved from memory 710, processor 702 controls the reception and manipulation of input data, and the output and display of data on output devices (e.g., display 718).

Processor 702 is coupled bi-directionally with memory 710, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also, as is well known in the art, primary storage typically includes basic operating instructions, program code, data, and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

Persistent memory 712 (e.g., a removable mass storage device) provides additional data storage capacity for computer system 700, and is coupled either bi-directionally (read/write) or uni-directionally (read only) to processor 702. For example, persistent memory 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Persistent memory 712 and fixed mass storage 720 generally store additional programming instructions, data, and the like that typically are not in active use by the processor 702. It will be appreciated that the information retained within persistent memory 712 and fixed mass storages 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, pointing device 706 can be a mouse, stylus, track ball, or tablet, and is useful for interacting with a graphical user interface.

Network interface 716 allows processor 702 to be coupled to another computer, computer network, or telecommunications network using a network connection as shown. For example, through network interface 716, processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect computer system 700 to an external network and transfer data according to standard protocols. Processes can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an indication to predict one or more additional steps to be added to a partially specified computerized workflow based at least in part on the partially specified computerized workflow;
generating text descriptive of at least a portion of the partially specified computerized workflow;
providing to a machine learning model, machine learning inputs based at least in part on the descriptive text to determine an output text descriptive of the one or more additional steps to be added; and
using one or more processors to automatically implement the one or more additional steps to be added to the partially specified computerized workflow.

2. The method of claim 1, wherein the indication to predict the one or more additional steps to be added is generated by a user via a graphical user interface.

3. The method of claim 1, wherein the partially specified computerized workflow has at least in part been specified manually by a user via a graphical user interface.

4. The method of claim 1, wherein the partially specified computerized workflow has at least in part been generated automatically.

5. The method of claim 1, wherein the one or more additional steps to be added belong to an enumerated collection of available steps that the machine learning model is permitted to output.

6. The method of claim 1, wherein generating the descriptive text includes converting data in an Extensible Markup Language (XML) or JavaScript Object Notation (JSON) format to a text format.

7. The method of claim 1, wherein the machine learning model is a text-to-text pre-trained model.

8. The method of claim 1, wherein the machine learning model has been pre-trained on a dataset and then fine-tuned for a prediction task.

9. The method of claim 1, wherein the machine learning model has been trained based at least in part on a plurality of training instances of synthetically generated training data.

10. The method of claim 9, wherein at least one training instance of the plurality of training instances comprises a flow representation that is divided into an initial steps portion and an additional steps portion at a randomly selected split point.

11. The method of claim 9, wherein the plurality of training instances is comprised of flow representations of different lengths.

12. The method of claim 11, wherein at least one flow representation of the flow representations of different lengths is comprised of flow steps selected according to a statistical distribution of flow steps.

13. The method of claim 1, further comprising providing to the machine learning model, context information comprising conditioning parameters for the machine learning model.

14. The method of claim 1, further comprising providing to the machine learning model, a selection of a tensor data object from a list of tensor data objects, wherein each tensor data object is of the list of tensor data objects is associated with different model weights for the machine learning model.

15. The method of claim 1, wherein using the one or more processors to automatically implement the one or more additional steps to be added includes causing the one or more processors to convert a text format prediction to one or more application programming interface messages.

16. The method of claim 15, wherein using the one or more processors to automatically implement the one or more additional steps to be added further includes transmitting the one or more application programming interface messages to an application configured to generate computerized workflow steps.

17. The method of claim 1, wherein the partially specified computerized workflow includes a trigger condition and at least one action step that is configured to execute in response to a determination that the trigger condition has occurred.

18. The method of claim 1, further comprising displaying in a graphical user interface a computerized workflow that combines the partially specified computerized workflow and the one or more additional steps to be added.

19. A system, comprising:
one or more processors configured to:
receive an indication to predict one or more additional steps to be added to a partially specified computerized workflow based at least in part on the partially specified computerized workflow;
generate text descriptive of at least a portion of the partially specified computerized workflow;
provide to a machine learning model, machine learning inputs based at least in part on the descriptive text to determine an output text descriptive of the one or more additional steps to be added; and
automatically implement the one or more additional steps to be added to the is partially specified computerized workflow; and
a memory coupled to at least one of the one or more processors and configured to provide at least one of the one or more processors with instructions.

20. A computer program product embodied in a non-transitory computer readable medium and comprising computer instructions for:
receiving an indication to predict one or more additional steps to be added to a partially specified computerized workflow based at least in part on the partially specified computerized workflow;
generating text descriptive of at least a portion of the partially specified computerized workflow;
providing to a machine learning model, machine learning inputs based at least in part on the descriptive text to determine an output text descriptive of the one or more additional steps to be added; and
automatically implementing the one or more additional steps to be added to the partially specified computerized workflow.
